(19) United States
(12) Patent Application Publication
(10) Pub. No.: US 2026/0103351 A1
(43) Pub. Date: Apr. 16, 2026

(54) DECHUCK CONTROL METHOD, DECHUCK CONTROL SYSTEM, METHOD OF TRANSFERRING SUBSTRATE

(71) Applicant: Samsung Display Co., LTD., Yongin-si (KR)

(72) Inventors: Yeong Min KIM, Yongin-si (KR); Dong Wook KIM, Yongin-si (KR); Yong Hyun KIM, Yongin-si (KR); Jang Hoon PARK, Yongin-si (KR); Shin Yang KIM, Yongin-si (KR); Sang Jin HAN, Yongin-si (KR)

(21) Appl. No.: 19/213,116

(22) Filed: May 20, 2025

(30) Foreign Application Priority Data
Oct. 14, 2024 (KR) 10-2024-0139683

(51) Int. Cl. B65G 47/90

(52) U.S. Cl. CPC B65G 47/905

(57) ABSTRACT

Provided herein may be a dechuck control method, a dechuck control system, and a method of transferring a substrate. The dechuck control method may include: providing a substrate and a carrier coupled to each other by an adhesive chuck; pushing the substrate by a dechuck pin including a pressure sensor, and acquiring, by the pressure sensor, pressure data associated with pushing the substrate by the dechuck pin; and controlling an operation of the dechuck pin based on the pressure data.

This application claims priority to Korean Patent Application No. 10-2024-0139683, filed on Oct. 14, 2024, and all the benefits accruing therefrom under 35 U.S.C. § 119, the content of which in its entirety is herein incorporated by reference.

### BACKGROUND

### Field

Various embodiments of the disclosure relate to a dechuck control method, a dechuck control system, and a method of transferring a substrate.

### Description of Related Art

A plurality of process steps are performed to fabricate electronic devices, such as, for example, display devices. At least some of the process steps may be performed in spatially separate process sections. There is a desire to appropriately transfer target objects to be processed (e.g., a substrate) from a preceding process section to a subsequent process section. For example, it is desirable to thoroughly secure the target objects to be processed to a carrier or the like to prevent the objects from being damaged during a process of transferring the objects between the process sections. Furthermore, after the process, techniques are desired for separating the target objects from the carrier or the like without the target objects or the carrier being damaged.

### SUMMARY

Various embodiments of the disclosure are directed to a dechuck control method, a dechuck control system, and a method of transferring a substrate, in which the reliability of the dechuck process with respect to the substrate and a carrier can be improved, thereby preventing damage to the substrate or the like.

Various embodiments of the disclosure are directed to a dechuck control method, a dechuck control system, and a method of transferring a substrate, in which process costs can be reduced and process monitoring with improved user convenience can be implemented.

Various embodiments of the disclosure are directed to a dechuck control method, a dechuck control system, and a method of transferring a substrate, in which whether individual steps of a dechuck process have been performed normally can be analyzed quantitatively.

An embodiment of the present disclosure may provide a dechuck control method, including: providing a substrate and a carrier coupled to each other by an adhesive chuck; pushing the substrate by a dechuck pin including a pressure sensor, and acquiring, by the pressure sensor, pressure data associated with pushing the substrate by the dechuck pin; and controlling an operation of the dechuck pin based on the pressure data.

In an embodiment, the adhesive chuck may include a first adhesive chuck, a second adhesive chuck, and a third adhesive chuck arranged sequentially along a dechuck direction. The dechuck pin may include a first dechuck pin located between the first adhesive chuck and the second adhesive chuck, and a second dechuck pin located between the second adhesive chuck and the third adhesive chuck. Acquiring the pressure data may include acquiring the pressure data by a pressure sensor of the second dechuck pin while the second dechuck pin pushes the substrate. The pressure data acquired by the pressure sensor of the second dechuck pin may be expressed as a first graph and a second graph, each representing a pressure value over time. The first graph may include the pressure value over time in a first time period, and the second graph may include the pressure value over time in a second time period following the first time period. The first graph may have a first peak value of the pressure value, the second graph may have an initial value and a second peak value of the pressure value, and the first peak value and the initial value may differ from each other by a gap value.

In an embodiment, for a case in which the first adhesive chuck, the second adhesive chuck, and the third adhesive chuck are sequentially separated from the substrate along the dechuck direction, a time point at which the first time period and the second time period are distinguished from each other may correspond to a time point at which the second adhesive chuck and the substrate are separated from each other.

In an embodiment, for a case in which the first adhesive chuck, the second adhesive chuck, and the third adhesive chuck are not sequentially separated from the substrate along the dechuck direction, a time point at which the first time period and the second time period are distinguished from each other may correspond to a time point at which the third adhesive chuck and the substrate are separated from each other.

In an embodiment, controlling the operation of the dechuck pin may include continuously pushing the substrate by the second dechuck pin in response to determining the pressure data meets a preset criterion.

In an embodiment, controlling the operation of the dechuck pin may include determining whether the pressure value as indicated in the first graph in the first time period is equal to or greater than a first reference value. Controlling the operation of the dechuck pin may include, in response to determining the pressure value as indicated in the first graph is equal to or greater than the first reference value, continuously pushing the substrate. Controlling the operation of the dechuck pin may include, in response to determining the pressure value as indicated in the first graph is less than the first reference value, determining whether the gap value is equal to or greater than a reference gap value.

In an embodiment, the method may include, in response to determining the gap value is equal to or greater than the reference gap value, continuously pushing the substrate by the dechuck pin. In response to determining the gap value is less than the reference gap value, determining whether the pressure value as indicated in the second graph in the second time period is equal to or greater than a second reference value.

In an embodiment, the method may include, in response to determining the pressure value as indicated in the second graph is equal to or greater than the second reference value, continuously pushing the substrate by the dechuck pin, and in response to determining the pressure value as indicated in the second graph is less than the second reference value, providing a warning signal.

In an embodiment, controlling the operation of the dechuck pin may further include: providing a re-entry number with an initial value when the second dechuck pin initially pushes the substrate; and after providing the warning signal, controlling the second dechuck pin such that the second dechuck pin is spaced apart from the substrate, suspending acquiring the pressure data by the pressure sensor of the second dechuck pin, and increasing the re-entry number by 1.

In an embodiment, controlling the operation of the dechuck pin may further include determining whether the re-entry number is greater than a setting count.

In an embodiment, the method may include providing an alarm signal in response to determining the re-entry number is greater than the setting count.

In an embodiment, the method may include, in response to determining the re-entry number is equal to or less than the setting count, pushing the substrate by the second dechuck pin according to a reduced push speed, and reacquiring the pressure data by the pressure sensor of the second dechuck pin.

Various embodiments of the disclosure are directed to a dechuck control system, including: an adhesive chuck which attaches a carrier including a pin hole to a substrate; a dechuck pin which pushes the substrate in a direction through the pin hole, and including a pressure sensor which acquires pressure data; and a controller which receives the pressure data and controls an operation of the dechuck pin based on the pressure data.

In an embodiment, the carrier may include a middle area and a peripheral area formed around the middle area and forming a dummy area. A chuck area where the pin hole and the adhesive chuck are positioned may be formed in the middle area. The chuck area may include a plurality of portions each extending in a direction.

In an embodiment, the pin hole and the adhesive chuck may be alternately arranged in the chuck area.

In an embodiment, the dechuck pin may include a body part including a first end and a second end, a tip provided on the first end and capable of pushing the substrate, and a pressure sensor provided on the second end.

In an embodiment, the dechuck control system may further include a pin plate including a plate hole, wherein the pressure sensor is located in the plate hole.

In an embodiment, the dechuck control system may further include: a signal amplifier connected to the pressure sensor; and a controller which provides a pressure measurement initiation signal to the signal amplifier, receive pressure information from the signal amplifier, and provide an operation control signal to the pressure sensor.

Various embodiments of the disclosure are directed to a transfer method, including: providing a substrate on a carrier; transferring the substrate; coupling the substrate and the carrier by an adhesive chuck; performing a certain process on the substrate; and performing a dechuck process with respect to the substrate and the carrier. Performing the dechuck process may include a plurality of unit dechuck processes. Performing each of the plurality of unit dechuck processes may include: providing the substrate and the carrier in a state in which the substrate and the carrier are attached to each other by the adhesive chuck; pushing the substrate by a dechuck pin, and acquiring, by a pressure sensor, pressure data associated with pushing the substrate by the dechuck pin; and controlling an operation of the dechuck pin based on the pressure data.

In an embodiment, the certain process may include a deposition process. Performing the dechuck process may include, as operations respectively corresponding to the plurality of unit dechuck processes, performing a first dechuck process using a first dechuck pin, and performing a second dechuck process using a second dechuck pin.

### BRIEF DESCRIPTION OF THE DRAWINGS

FIG. 1 is a schematic diagram illustrating a structure for transferring a substrate and a carrier between process sections in accordance with an embodiment.

FIG. 2 is a schematic flowchart illustrating a method of transferring the substrate in accordance with an embodiment.

FIGS. 3, 4, 7, and 8 are schematic sectional views illustrating the method of transferring the substrate for respective process steps in accordance with an embodiment.

FIGS. 5 and 6 are schematic plan views illustrating a carrier and a portion of an area overlapping the carrier in accordance with an embodiment.

FIG. 9 is a schematic diagram illustrating a dechuck control system in accordance with an embodiment.

FIG. 10 is a flowchart illustrating the steps of performing a dechuck process with respect to the substrate and the carrier in accordance with an embodiment.

FIG. 11 is a flowchart illustrating a unit dechuck process in accordance with an embodiment.

FIG. 12 is a flowchart illustrating in further detail a unit dechuck process in accordance with an embodiment.

FIG. 13 is a graph illustrating pressure data measured during the dechuck process steps in the case where the substrate and the carrier are normally separated from each other in accordance with an embodiment.

FIGS. 14 to 17 are schematic sectional views illustrating the dechuck process steps in the case where the substrate and the carrier are normally separated from each other in accordance with an embodiment.

FIG. 18 is a graph illustrating pressure data measured during the dechuck process steps in the case where the substrate and the carrier are abnormally separated from each other in accordance with an embodiment.

FIGS. 19 to 22 are schematic sectional views illustrating the dechuck process steps in the case where the substrate and the carrier are abnormally separated from each other in accordance with an embodiment.

### DETAILED DESCRIPTION

As the disclosure allows for various changes and numerous embodiments, particular embodiments will be illustrated in the drawings and described in detail in the written description. However, this is not intended to limit the disclosure to particular modes of practice, and it is to be appreciated that all changes, equivalents, and substitutes that do not depart from the spirit and technical scope of the disclosure are encompassed in the disclosure.

It will be understood that, although the terms “first”, “second”, and the like may be used herein to describe various elements, these elements should not be limited by these terms. These terms are used to distinguish one element from another element. For instance, a first element discussed below could be termed a second element without departing from the teachings of the disclosure. Similarly, the second element could also be termed the first element. In the disclosure, the singular forms are intended to include the plural forms as well, unless the context clearly indicates otherwise.

It will be further understood that the terms “comprise”, “include”, “have”, and the like when used in the disclosure, specify the presence of stated features, integers, steps, operations, elements, components, and/or combinations of them but do not preclude the presence or addition of one or more other features, integers, steps, operations, elements, components, and/or combinations thereof. Furthermore, for a case in which a first part, such as, for example, a layer, a film, a region, or a plate, is disposed on a second part, the first part may be directly on the second part or a third part may intervene between them. In some aspects, in the case where it is expressed that a first part, such as, for example, a layer, a film, a region, or a plate, is formed on a second part, the surface of the second part on which the first part is formed is not limited to an upper surface of the second part but may include other surfaces, such as a side surface or a lower surface of the second part. To the contrary, for a case in which a first part, such as, for example, a layer, a film, a region, or a plate, is under a second part, the first part may be directly under the second part or a third part may intervene between them.

Various embodiments of the disclosure relate to a dechuck control method, a dechuck control system, and a method of transferring a substrate. Hereinafter, a dechuck control method, a dechuck control system, and a method of transferring a substrate in accordance with an embodiment will be described with reference to the accompanying drawings.

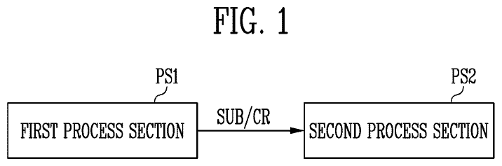

FIG. 1 is a schematic diagram illustrating a structure for transferring a substrate SUB and a carrier CR between process sections in accordance with an embodiment.

Referring to FIG. 1, the substrate SUB along with the carrier CR may be transferred between process sections PS1 and PS2 located at different positions. In an embodiment, the substrate SUB and the carrier CR may be coupled to each other. For example, the substrate SUB and the carrier CR may be physically attached to each other and transferred together.

The substrate SUB and the carrier CR that are coupled to each other may be transferred between a first process section PS1 where a first process is performed in a first time period and a second process section PS2 where a second process (e.g., a deposition process) is performed in a second time period. The first process and the second process are not limited to specific examples, and may refer to processes which are respectively performed in the first process section PS1 and the second process section PS2, which are different from each other.

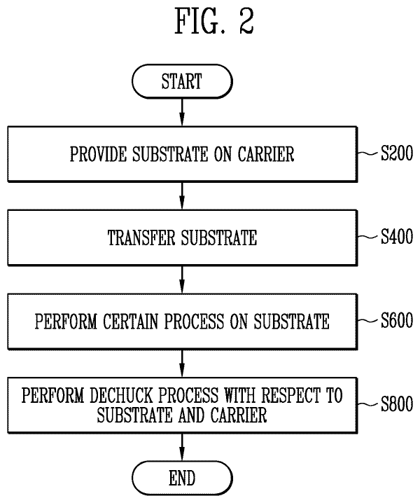

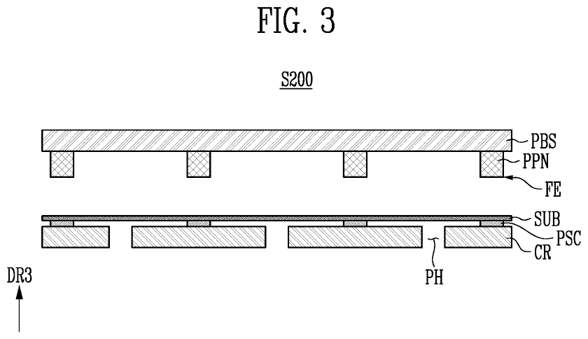

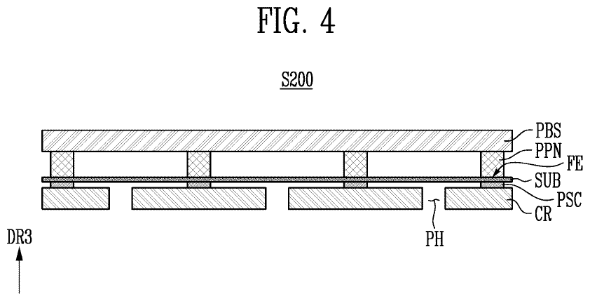

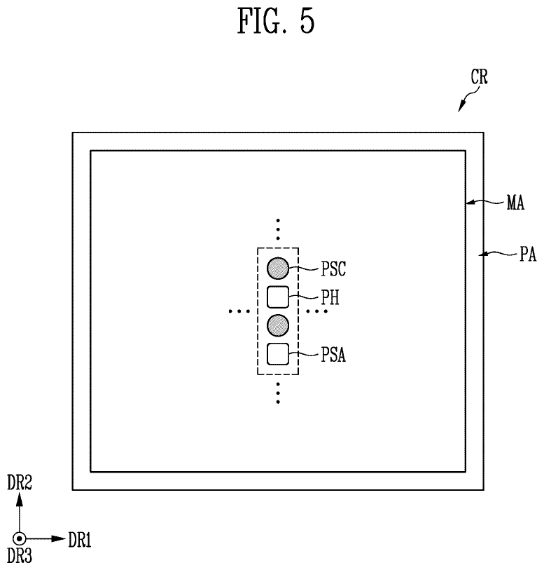

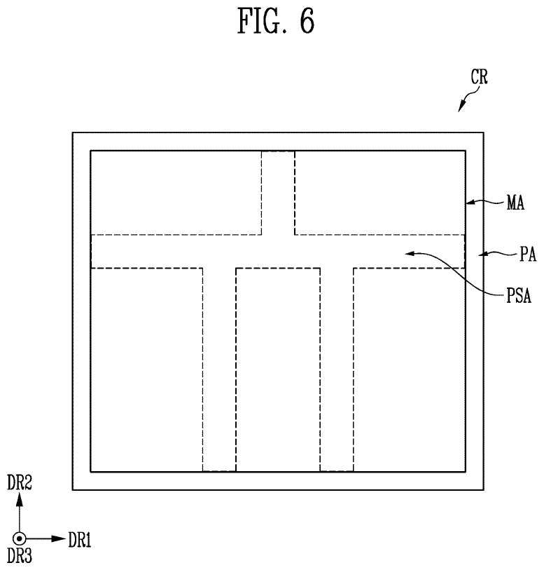

FIG. 2 is a schematic flowchart illustrating a method of transferring the substrate SUB in accordance with an embodiment. FIGS. 3, 4, 7, and 8 are schematic sectional views illustrating the method of transferring the substrate SUB for respective process steps in accordance with an embodiment. FIGS. 5 and 6 are schematic plan views illustrating the carrier CR and a portion of an area overlapping the carrier CR in accordance with an embodiment.

In the descriptions of the method and processes herein, the operations may be performed in a different order than the order shown and/or described, or the operations may be performed in different orders or at different times. Certain operations may also be left out of the flowcharts, one or more operations may be repeated, or other operations may be added. Descriptions that an element “may be moved,” “may be disposed,” “may be formed,” and the like include methods, processes, and techniques for moving, disposing, forming, positioning, and modifying the element, and the like in accordance with example aspects described herein.

Referring to FIGS. 2 to 8, the method of transferring the substrate SUB in accordance with an embodiment may be a process procedure including moving the substrate SUB using the carrier CR, performing a process (e.g., a deposition process) for the substrate SUB, and then separating the substrate SUB from the carrier CR. For example, the method of transferring the substrate SUB may encompass a process procedure in which the substrate SUB provided separately from the carrier CR is moved using the carrier CR and then separated from the carrier CR.

In an embodiment, the method of transferring the substrate SUB may include step S200 of providing the substrate SUB on the carrier CR, step S400 of transferring the substrate SUB, step S600 of performing a certain process on the substrate SUB, and step S800 of performing a dechuck process with respect to the substrate SUB and the carrier CR.

Referring to FIG. 2 to 6, at step S200 of providing the substrate SUB on the carrier CR, the substrate SUB and the carrier CR may be coupled to each other by an adhesive chuck PSC.

In an embodiment, a transfer apparatus for transferring the substrate SUB may include the carrier CR, the adhesive chuck PSC, a pin base PBS, and an adhesive pin PPN.

The substrate SUB may be a component provided to fabricate an electronic device (e.g., a display device or the like). The substrate SUB may be a base provided to place (e.g., form) a plurality of layers thereon. In an embodiment, the substrate SUB may be a rigid substrate or a flexible substrate. For example, the substrate SUB may include glass, silicon, sapphire, gallium arsenide (GaAs), silicon carbide (SiC), or the like. However, the disclosure is not limited to the aforementioned example.

The carrier CR may be a component coupled to the substrate SUB to transfer the substrate SUB. The carrier CR may include rigid materials such as, for example, various metals and plastics, and may have a relatively flat surface. However, the disclosure is not limited to a specific example.

The carrier CR may include a pin hole PH. A plurality of pin holes PH may be provided. The pin hole PH may pass through the carrier CR in a thickness direction of the carrier CR (e.g., in a third direction DR3). The pin hole PH may be an area where a dechuck pin PN is provided in a subsequent process.

The carrier CR may include a middle area MA and a peripheral area PA. The middle area MA may be an internal area, and the peripheral area PA may be formed around the middle area MA. In an embodiment, the peripheral area PA may be a dummy area, and may be an area which does not overlap the substrate SUB.

A chuck area PSA may be formed in the middle area MA. The chuck area PSA formed in the middle area MA may be an area where the adhesive chuck PSC and the pin hole PH are formed (e.g., located). In an embodiment, the chuck area PSA may be partially formed in the central portion MA. For example, the chuck area PSA may include a plurality of portions each extending in a direction. The middle area MA may include a plurality of areas separated by the chuck area PSA. For instance, a portion of the chuck area PSA may extend in a first direction DR1, and another portion of the chuck area PSA may extend in a second direction. The middle area MA may include a plurality of areas separated by the portions of the chuck area PSA. Here, a range in which the portions of the chuck area PSA are located is not limited to the aforementioned example.

In the chuck area PSA, adhesive chucks PSC and pin holes PH may be alternately arranged. For example, each adhesive chuck PSC may be located between adjacent pin holes PH, and each pin hole PH may be located between adjacent adhesive chucks PSC.

The term “adjacent” herein may refer to elements which are relatively close to each other (e.g., within a target distance). In some other cases, the term “adjacent” herein may refer to elements which are in contact with each other. In some cases, the term “adjacent” herein may refer to elements of the same type, in which another element of the same type is not disposed between the elements. For example, for a pin hole PH described as adjacent to another pin hole PH, another pin hole PH is not present between the adjacent pin holes PH.

The adhesive chuck PSC may be attached to the substrate SUB using physical adhesive force or detached from the substrate SUB. The adhesive chuck PSC may be placed on the carrier CR, and may be formed (or located) in an area adjacent to the pin hole PH. For example, the adhesive chuck PSC may be located between adjacent pin holes PH.

The pin base PBS and the adhesive pin PPN may push an upper surface of the substrate SUB such that the substrate SUB and the adhesive chuck PSC can be closely coupled to each other.

The pin base PBS may extend in a direction of a plane in which the carrier CR is placed. The pin base PBS may form an area (e.g., a base) where the adhesive pin PPN is positioned.

The adhesive pin PPN may be provided on a surface of the pin base PBS. A plurality of adhesive pins PPN may be provided. The adhesive pins PPN may extend in the thickness direction of the pin base PBS (e.g., in the third direction DR3). A free end FE of each of the adhesive pins PPN may be oriented toward the substrate SUB. In an embodiment, adhesive pins PPN be formed at positions corresponding to the respective adhesive chucks PSC.

At step S200, the substrate SUB may be placed to contact the adhesive chuck PSC on the carrier CR. For example, a rear surface of the substrate SUB may be directly adjacent to the adhesive chuck PSC.

At step S200, the adhesive pin PPN and the substrate SUB may be adjacent to each other, and the adhesive pin PPN may push the upper surface of the substrate SUB. For example, the free end FE of the adhesive pin PPN may contact the upper surface of the substrate SUB. Accordingly, the substrate SUB and the adhesive chuck PSC may closely adhere to each other, and the substrate SUB may be coupled to the carrier CR. The rear surface of the substrate SUB may be coupled to each of the adhesive chucks PSC.

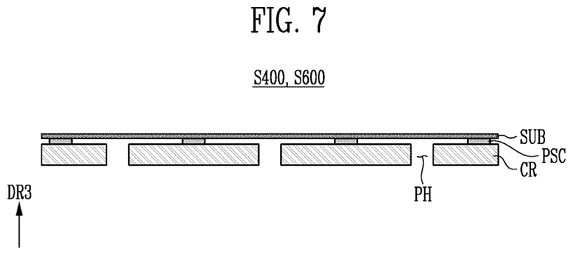

Referring to FIGS. 2 and 7 along with FIG. 1, at step S400 of transferring the substrate SUB, the method may include transferring the substrate SUB and the carrier CR from the first process section PS1 to the second process section PS2.

At step S400, the method may include maintaining the substrate SUB and the carrier CR in a coupled state by using the adhesive chuck PSC. The carrier CR may thoroughly secure the position of the substrate SUB.

Referring to FIGS. 2 and 7, at step S600 of performing a certain process on the substrate SUB, the method may include performing a certain process on the substrate SUB that has been transferred to the second process section PS2.

At step S600, the method may include performing various processes on the substrate SUB. For example, a deposition process may be performed on the substrate SUB that has been transferred to the second process section PS2. However, the disclosure is not limited to the aforementioned example.

At step S600, the method may include maintaining the substrate SUB and the carrier CR in a coupled state by using the adhesive chuck PSC.

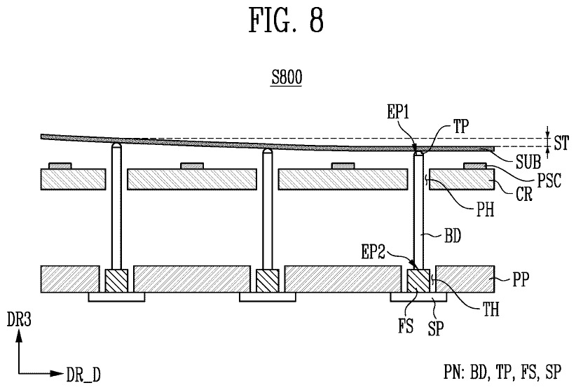

Referring to FIGS. 2 and 8, at step S800 of performing a dechuck process with respect to the substrate SUB and the carrier CR, the method may include pushing, by the dechuck pin PN, the rear surface of the substrate SUB, and the substrate SUB and the carrier CR may be spaced apart (e.g., separated) from each other.

In an embodiment, the transfer apparatus may include a pin plate PP and the dechuck pin PN.

The pin plate PP may extend in the direction of the plane in which the carrier CR is placed. The pin plate PP may form an area (e.g., a base) where the dechuck pin PN is positioned. The pin plate PP may include relatively rigid material. However, the disclosure is not limited to the aforementioned example.

The pin plate PP may be provided with a plate hole TH defined through the pin plate PP. A plurality of plate holes TH may be provided. The plate hole TH may pass through the pin plate PP in a thickness direction of the pin plate PP (e.g., in the third direction DR3). Descriptions herein that an element (e.g., pin plate PP) “may be provided with” another element (e.g., an opening, a plate hole TH) include descriptions of the other element being formed in or on the element.

In an embodiment, the plate hole TH may form an area where at least a portion of the dechuck pin PN (e.g., a pressure sensor FS) is located. In an embodiment, the pressure sensor FS may be received in the plate hole TH. The pressure sensor TS may more clearly acquire information about a pressure transmitted to the dechuck pin FN.

Embodiments of the present disclosure may include controlling the dechuck pin PN to push the rear surface of the surface SUB such that the adhesion between the substrate SUB and the adhesive chuck PSC can be released. For example, the dechuck pin PN (e.g., a body part BD and a tip TP) may move in upward and downward directions (e.g., the third direction DR3).

Descriptions herein of dechuck pin PN moving or being moved in a direction may include controlling movement of the dechuck pin PN by using equipment (e.g., a controller) in a process described herein.

The dechuck pin PN may include the body part BD, the tip TP, the pressure sensor FS, and a Support Member Sp.

The body part BD may support the entire structure of the dechuck pin PN. The body part BD may extend in the thickness direction of the carrier CR (e.g., the third direction DR3). The body part BD may include polyether ether ketone (PEEK). However, the disclosure is not limited to the aforementioned example. The body part BD may include a first end EP1 oriented toward the substrate SUB, and a second end EP2 oriented toward the pressure sensor FS.

The tip TP may be provided on the first end EP1 of the body part BD. The tip TP may push the rear surface of the substrate SUB. The tip TP may move such that the tip TP is directly adjacent to (e.g., in contact with) the substrate SUB. The tip TP may extend toward and push the substrate SUB or move away from the substrate SUB depending on the operation of the dechuck pin PN. The tip TP may include synthetic rubber (e.g., fluoropolymer elastomer). However, the disclosure is not limited to the aforementioned example.

The pressure sensor FS may be provided on the second end EP2 of the body part BD. The pressure sensor FS may acquire pressure data generated from the substrate SUB and an area adjacent to the substrate SUB (e.g., an area connected to the substrate SUB). In an embodiment, the pressure sensor FS may be connected to the body part BD through the second end EP2. For example, a pressure generated from the substrate SUB may be transmitted to the pressure sensor FS through the tip TP and the body part BD. The pressure sensor FS may acquire information (e.g., data) about the pressure generated from the substrate SUB. The pressure sensor FS may be formed using quartz material. However, the disclosure is not limited to the aforementioned example.

In an embodiment, at least a portion of the pressure sensor FS may be located in the plate hole TH. Accordingly, as described herein, the risk of the pressure data acquired by the pressure sensor FS being altered by external influences may be reduced, and the reliability of the acquired pressure data may be enhanced.

The support member SP may support a lower portion of the pressure sensor FS and a lower portion of the body part BD. For example, the support member SP may include rigid material. The support member SP may extend to have a relatively large surface area, and may cover the entirety of a single plate hole TH.

The dechuck pin PN may move in the upward and downward directions (e.g., the third direction DR3). In an example in which the dechuck pin PN moves upward, the tip TP may push one surface of the substrate SUB. In an example in which the dechuck pin PN moves downward, the tip TP may move away from the substrate SUB, or the magnitude with which the tip TP pushes the substrate SUB may be reduced.

At step S800, the dechuck pins PN may sequentially push a surface of the substrate SUB. Accordingly, the adhesive chucks PSC may be sequentially spaced apart from the substrate SUB. For example, the dechuck pins PN may sequentially push the substrate SUB in a dechuck direction DR_D, such that the adhesion state between the substrate SUB and the adhesive chucks PSC arranged in the dechuck direction DR_D may be sequentially released.

In an embodiment, the distance by which the dechuck pin PN pushes the substrate SUB at a preceding time point may be greater than the distance by which another dechuck pin PN pushes the substrate SUB at a subsequent time point. Accordingly, in a specific time period, the tip TP of the dechuck pin PN that pushes the substrate SUB at a preceding time point may be formed at a higher position than the tip TP of another dechuck pin PN that pushes the substrate SUB at a subsequent time point. In this case, the substrate SUB may form a step difference ST with varying heights across different areas.

Experimentally, the dechuck pins PN may push the substrate SUB sequentially along the dechuck direction DR_D, and the step difference ST may be formed as the process proceeds. To prevent the risk of damage to the substrate SUB due to the step difference ST, it may be desirable for the adhesive chucks PSC to be sequentially moved away from the substrate SUB along the dechuck direction DR_D. For example, based on the dechuck direction DR_D, in the case where the adhesive chuck PSC at a subsequent position moves away from the substrate SUB earlier than the adhesive chuck PSC at a preceding position, an excessive stress may be applied to the substrate SUB.

In an embodiment, a dechuck control system SYS that can prevent the aforementioned risk may be provided. Related details will be described later.

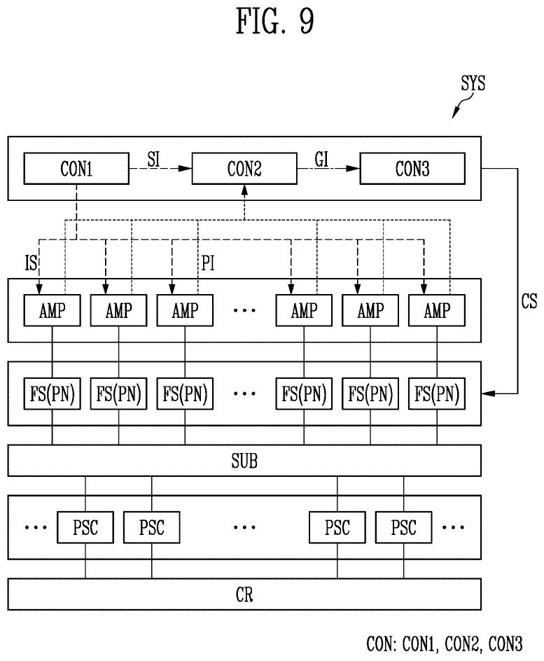

FIG. 9 is a schematic diagram illustrating the dechuck control system SYS in accordance with an embodiment.

Referring to FIG. 9, the dechuck control system SYS in accordance with an embodiment may include the aforementioned transfer apparatus (e.g., the carrier CR, the adhesive chuck PSC, the substrate SUB, and the dechuck pin PN), and may further include a controller CON and a signal amplifier AMP.

In an embodiment, the carrier CR may be coupled to the substrate SUB by each of the adhesive chucks PSC. The dechuck pin PN including the pressure sensor FS may be configured to apply pressure to a partial area of the substrate SUB that is not connected to the adhesive chuck PSC. The dechuck pin PN may push the substrate SUB in an area between adjacent adhesive chucks PSC. Hence, the pressure sensor FS may acquire pressure data generated from an area adjacent to the corresponding dechuck pin PN.

For example, the pressure sensor FS may acquire pressure data generated as a result of adhesion and release between the substrate SUB and the adhesive chucks PSC adjacent to the corresponding dechuck pin PN. In an embodiment, based on the pressure data acquired by the pressure sensor FS, the adhesion state and released state between the substrate SUB and the adjacent adhesive chucks PSC may be analyzed.

In an embodiment, each of the pressure sensors FS may be connected to the corresponding signal amplifier AMP. The signal amplifier AMP may receive pressure data acquired by the pressure sensor FS, and may transmit pressure information PI to the controller CON based on the received pressure data. For example, the signal amplifier AMP may amplify the received pressure data, thus acquiring pressure information PI.

In an embodiment, the signal amplifier AMP may receive the pressure data (e.g., an analog signal) provided from the pressure sensor FS through various connection methods. For example, the signal amplifier AMP may receive the pressure data through a serial communication method (e.g., an RS-232C method). However, the disclosure is not limited to the aforementioned example.

The controller CON may be configured to control the overall operations of the dechuck control system SYS. For example, the controller CON may be implemented as hardware, software, or a combination thereof. Unless otherwise specified, the overall operations of the dechuck control system SYS may be understood as being performed by the controller CON.

The controller CON may include a first controller CON1, a second controller CON2, and a third controller CON3. In an embodiment, the first controller CON1, the second controller CON2, and the third controller CON3 may be electrically connected to each other and provide electrical signals to one another or to other components. For example, the first controller CON1, the second controller CON2, and the third controller CON3 may be connected to each other based on an Ethernet method, but the disclosure is not limited thereto.

The first controller CON1 may provide a pressure measurement initiation signal IS (e.g., a digital signal) to the pressure sensor FS through the signal amplifier AMP. As the pressure measurement initiation signal IS is applied to the pressure sensor FS, the pressure sensor FS may acquire pressure data including information about the pressure generated on the substrate SUB.

The first controller CPN1 may be a programmable logic controller (PLC). For example, the first controller CON1 is related to a process automation control device and may control the operation of the components.

The second controller CON2 may receive the pressure information PI from the signal amplifier AMP, and may receive general information SI about the operation status of the substrate SUB and components around the substrate SUB from the first controller CON1. For example, the general information SI may include the operation status and height of the dechuck pin PN, the status of the substrate SUB and the carrier CR, and the like. The pressure disclosure is not limited to a specific example. The second controller CON2 may synthesize the received information and transmit the synthesized information GI to the third controller CON3.

The second controller CON2 may be a modular controller. For example, the second controller CON2 may be a controller including a plurality of modules.

The third controller CON3 may receive the synthesized information GI and control the operation of components based on data in the process or the like. The third controller CON3 may be a manufacturing execution system (MES). However, the disclosure is not limited to the aforementioned example.

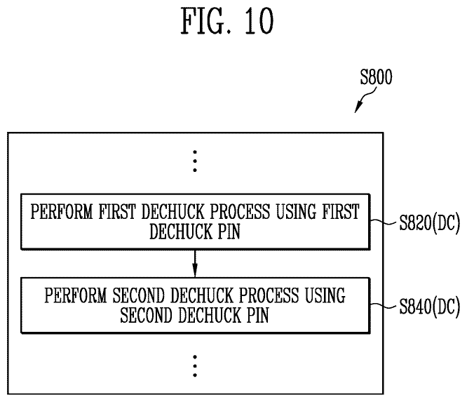

In an embodiment, the controller CON may control the operation of the dechuck pin PN based on the pressure data acquired by the pressure sensor FS. For example, the controller CON may provide an operation control signal CS to the dechuck pin PN, and the operation status of the dechuck pin PN can change based on the operation control signal CS. With regard to the foregoing, details will be explained with reference to FIG. 10 and the following drawings.

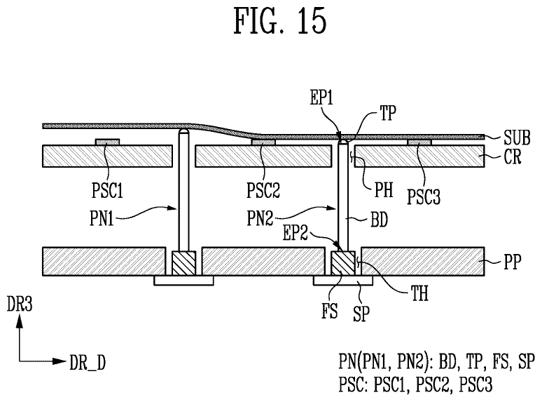

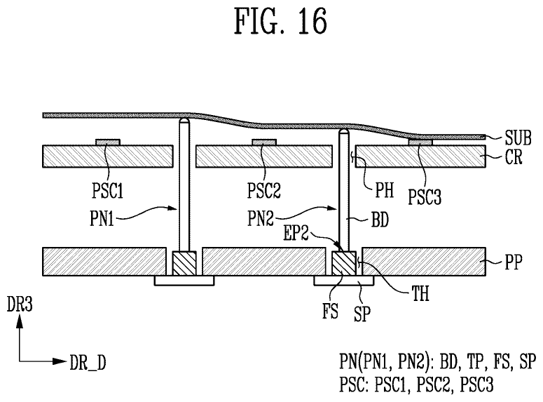

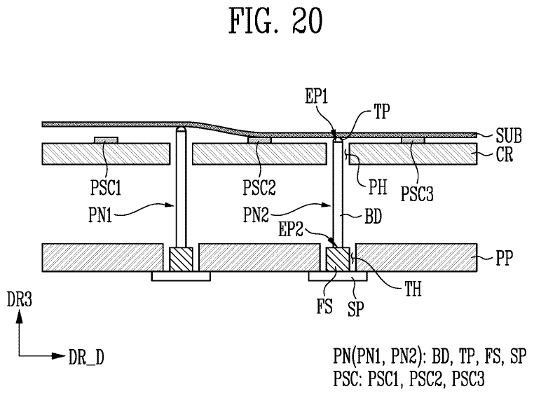

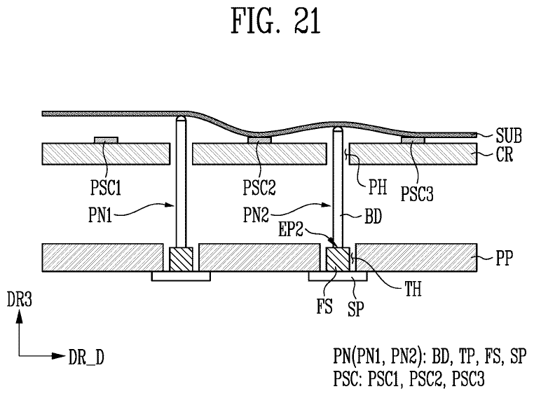

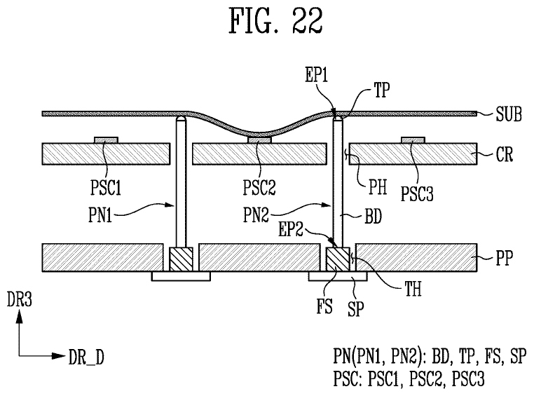

A dechuck control method in accordance with an embodiment will be described with reference to FIGS. 10 to 22. For the sake of convenience in explanation, descriptions of content that overlap the contents described herein will be simplified or omitted.

FIGS. 10 to 22 illustrate step S800 of performing the above-mentioned dechuck process with respect to the substrate SUB and the carrier CR.

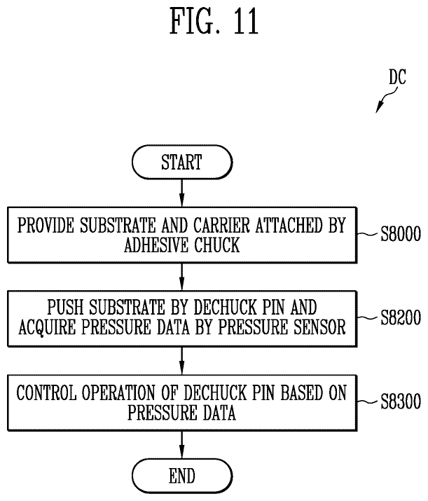

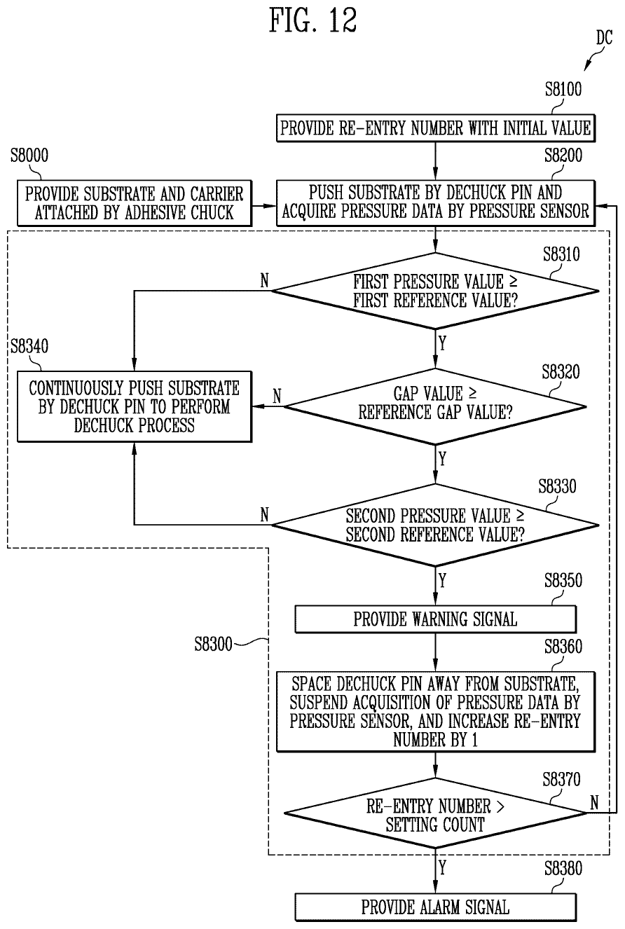

FIG. 10 is a flowchart illustrating the steps of performing the dechuck process with respect to the substrate SUB and the carrier CR in accordance with an embodiment. FIG. 10 illustrates a plurality of unit dechuck processes DC. FIG. 11 is a flowchart illustrating a unit dechuck process DC in accordance with an embodiment. FIG. 12 is a flowchart illustrating in further detail the unit dechuck process DC in accordance with an embodiment.

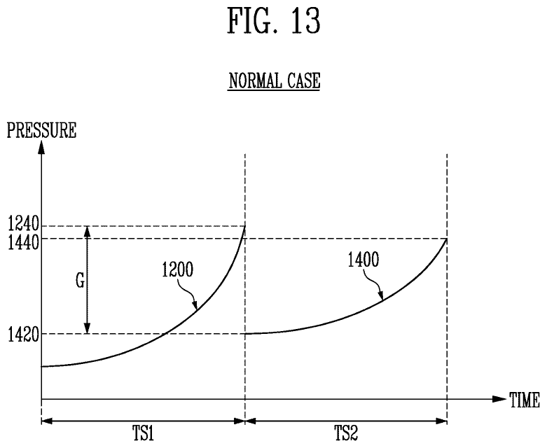

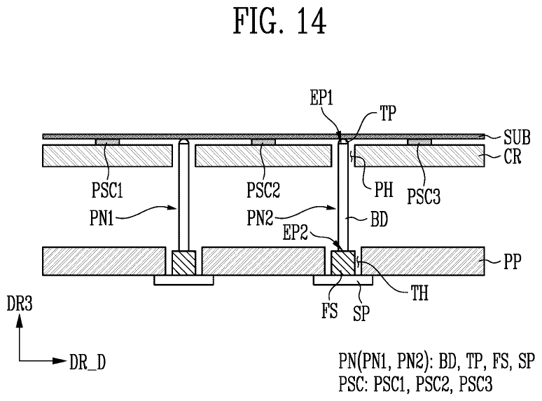

FIG. 13 is a graph illustrating pressure data measured during the dechuck process steps in the case where the substrate SUB and the carrier CR are normally moved away from each other in accordance with an embodiment. FIGS. 14 to 17 are schematic sectional views illustrating the dechuck process steps in the case where the substrate SUB and the carrier CR are normally moved away from each other in accordance with an embodiment.

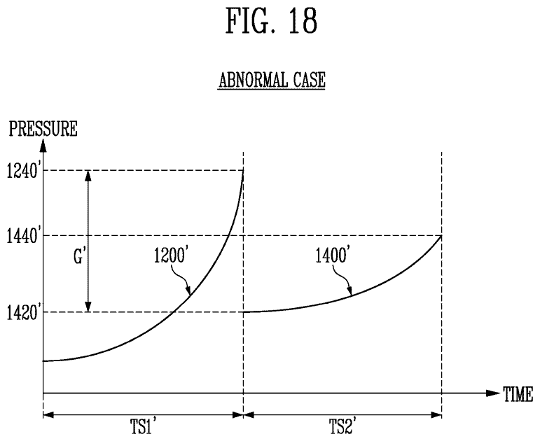

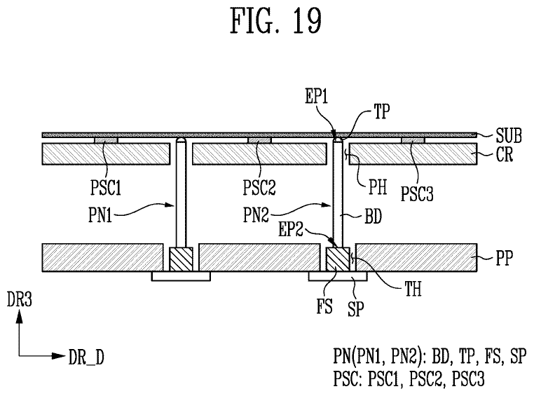

FIG. 18 is a graph illustrating pressure data measured during the dechuck process steps in the case where the substrate SUB and the carrier CR are abnormally moved away from each other in accordance with an embodiment. FIGS. 19 to 22 are schematic sectional views illustrating the dechuck process steps in the case where the substrate SUB and the carrier CR are abnormally moved away from each other in accordance with an embodiment.

Referring to FIG. 10, step S800 of performing the dechuck process with respect to the substrate SUB and the carrier CR may include a plurality of unit dechuck processes DC.

In an embodiment, the substrate SUB and the carrier CR may be coupled to each other by a plurality of adhesive chucks PSC. To perform the dechuck process with respect to the substrate SUB and the carrier CR, the method may include controlling a plurality of dechuck pins PN such that the plurality of dechuck pins PN push against the substrate SUB.

In an embodiment, the method may include using each of the dechuck pins PN in association with performing a respective dechuck process. For example, any one of the dechuck pins PN may perform a single dechuck process, and another one of the dechuck pins PN may perform a different dechuck process. As each of the dechuck pins PN performs a dechuck process, a plurality of unit dechuck processes DC may be sequentially performed.

For example, step S800 of performing the dechuck process with respect to the substrate SUB and the carrier CR may include step S820 of performing a first dechuck process using a first pin and step S840 of performing a second dechuck process using a second pin. Step S800 of performing the dechuck process with respect to the substrate SUB and the carrier CR may further include a plurality of additional unit dechuck processes DC. The number of unit dechuck processes DC may vary depending on the number of dechuck pins PN, and is not limited to a specific example.

During the unit dechuck process DC, the method may include using the dechuck pin PN in association with pushing the substrate SUB such that at least a portion of the substrate SUB moves away from the adhesive chuck PSC, and the method may include controlling the operation of the dechuck pin PN based on the pressure data acquired by the pressure sensor FS.

For example, referring to FIG. 11, the unit dechuck process DC may include step S8000 of providing the substrate SUB and carrier CR attached to each other by the adhesive chucks PSC, step S8200 of pushing the substrate SUB by the dechuck pin PN and acquiring pressure data by the pressure sensor FS, and step S8300 of controlling the operation of the dechuck pin PN based on the pressure data.

In an embodiment, the method may include releasing the adhesion state between the adhesive chuck PSC and the substrate SUB using the dechuck pin PN, and the method may include determining whether excessive stress is generated on the substrate SUB based on the pressure data acquired by the pressure sensor FS according to a preset criterion.

In an embodiment, based on the pressure data, the method may include controlling a push speed of the dechuck pin PN. For example, based on the pressure data, the method may include decreasing the push speed.

In an embodiment, based on the pressure data, in the case where the method determines that there is a possibility a dechuck process has occurred abnormally, the method may include providing a warning signal to a user.

In an embodiment, based on the pressure data, the method may include suspending the push operation of the dechuck pin PN.

In an embodiment, in the case where the method determines that there is a possibility a dechuck process has abnormally occurred based on the pressure data, the method may include providing a warning signal to a user.

Consequently, the method may include controlling the operation of the dechuck pin PN based on the acquired pressure data, thereby reducing the process risk that may arise if the dechuck process proceeds abnormally.

For example, the method may include controlling the push speed of the dechuck pin PN to reduce the risk of damage to the substrate SUB.

Furthermore, a warning signal and an alarm signal may be provided to the user, thereby providing notifications based on which the user may clearly recognize whether to check a current progress of the dechuck process.

In some aspects, as the dechuck process proceeds, the push operation of the dechuck pin PN may be suspended, thereby reducing the risk of damage to the substrate SUB due to an abnormally performed dechuck process.

Consequently, the reliability of the dechuck process with respect to the substrate SUB and the carrier CR may be enhanced, and the process yield may be improved, thereby reducing process costs.

The unit dechuck process DC in accordance with an embodiment will be described in more detail with reference to FIG. 12 and subsequent drawings.

Referring to FIG. 12, the unit dechuck process DC may include step S8000 of providing the substrate SUB and carrier CR attached to each other by the adhesive chucks PSC, step S8200 of pushing the substrate SUB by the dechuck pin PN and acquiring pressure data by the pressure sensor FS, and step S8300 of controlling the operation of the dechuck pin PN based on the pressure data, and may further include step S8100 of providing a re-entry number with an initial value.

Step S8300 of controlling the operation of the dechuck pin PN based on the pressure data may include step S8310 of determining whether a first pressure value is equal to or greater than a first reference value, step S8320 of determining whether a gap value is equal to or greater than a reference gap value, step S8330 of determining whether a second pressure value is equal to or greater than a second reference value, step S8340 of continuously pushing the substrate SUB using the dechuck pin PN and proceeding with the dechuck process, step S8350 of providing a warning signal, step S8360 of spacing the dechuck pin PN away from the substrate SUB, suspending acquisition of the pressure data by the pressure sensor FS, and increasing a re-entry number by 1, step S8370 of determining whether the re-entry number is greater than a setting count, and step S8380 of providing an alarm signal.

In an embodiment, during the unit dechuck process DC, the dechuck pins PN may push the substrate SUB sequentially along the dechuck direction DR_D.

Here, in the case where the dechuck process is normally performed (e.g., refer to FIGS. 13 to 17), the adhesive chucks PSC may be separated from (e.g., spaced apart from) the substrate SUB sequentially along the dechuck direction DR_D. However, in the case where the dechuck process is abnormally performed (e.g., refer to FIGS. 18 to 22), at least some of the adhesive chucks PSC may not be separated from (e.g., spaced apart from) the substrate SUB sequentially along the dechuck direction DR_D.

In an embodiment, in the case where the dechuck process is normally performed, the unit dechuck process DC may proceed according to appropriate corresponding process steps. In the case where the dechuck process is abnormally performed, the unit dechuck process DC may proceed according to appropriate corresponding process steps.

In an embodiment, detailed steps of the unit dechuck process DC may be performed. In the case where the dechuck process is normally performed, certain steps may proceed, and the case where the dechuck process is abnormally performed, other certain steps may proceed

FIGS. 13 to 22 illustrate an embodiment in which, along the dechuck direction DR_D, a first dechuck pin PN1 performs a dechuck process (e.g., a unit dechuck process DC) and, thereafter, a second dechuck pin PN2 performs a dechuck process (e.g., a unit dechuck process DC).

FIGS. 13 and 18 are graphs illustrating pressure values acquired by the pressure sensor FS formed in the second dechuck pin PN2 over time. FIGS. 13 and 18 schematically illustrate the trend of pressure data measured by the pressure sensor FS over time.

In the case of a normal dechuck process, a first adhesive chuck PSC1 may be separated from the substrate SUB, followed by a second adhesive chuck PSC2 being separated from the substrate SUB, and then a third adhesive chuck PSC3 may be separated from the substrate SUB. However, in the case where the dechuck process is abnormally performed, the order of the separation operation between at least some of the adhesive chucks PSC and the substrate SUB may be reversed with respect to the dechuck direction DR_D. For example, the first adhesive chuck PSC1 may be separated from the substrate SUB, and thereafter the third adhesive chuck PSC3 may be separated from the substrate SUB before the second adhesive chuck PSC2 is separated from the substrate SUB. In this case, it may be determined that the dechuck process has been performed abnormally, and it is desirable to appropriately control the operation of the dechuck pins PN or the like.

Descriptions herein of an adhesive chuck (e.g., first adhesive chuck PSC1, second adhesive chuck PSC2, or the like) being separated from the substrate SUB may refer to descriptions of an associated dechuck pin PN (e.g., first dechuck pin PN1, second dechuck pin PN2, or the like) pushing against a portion of the substrate SUB such that the portion of the substrate SUB is not in contact with the adhesive chuck.

With reference to FIGS. 12 to 17, detailed steps of the unit dechuck process DC will be described for the case where the dechuck process is performed normally.

Referring to FIGS. 12, 14, and 15, at step S8000 of providing the substrate SUB and the carrier CR attached to each other by the adhesive chucks PSC, the method may include providing the substrate SUB and the carrier CR coupled to each other.

In an embodiment, a unit dechuck process DC based on the first dechuck pin PN1 may be performed before a unit dechuck process DC based on the second dechuck pin PN2 is performed. For example, the first dechuck pin PN1 may push the rear surface of the substrate SUB through the pin hole PH between the first adhesive chuck PSC1 and the second adhesive chuck PSC2, thus spacing the first adhesive chuck PSC1 away from the substrate SUB.

In an embodiment, the first adhesive chuck PSC1, the second adhesive chuck PSC2, and the third adhesive chuck PSC3 may be arranged sequentially along the dechuck direction DR_D. The first dechuck pin PN1 may be placed between the first adhesive chuck PSC1 and the second adhesive chuck PSC2. The second dechuck pin PN2 may be placed between the second adhesive chuck PSC2 and the third adhesive chuck PSC3.

Referring to FIGS. 12, 14, and 15, at step S8100 of providing the re-entry number with the initial value, the method may include providing an initial value of 0 for the re-entry number, which indicates information about the number of operations of the second dechuck pin PN2.

In an embodiment, in the case where the re-entry number of the second dechuck pin PN2 is provided as the initial value, the second dechuck pin PN2 may contact a portion of the rear surface of the substrate SUB through the pin hole PH between the second adhesive chuck PSC2 and the third adhesive chuck PSC3. Accordingly, the pressure sensor FS of the second dechuck pin PN2 may acquire information about pressure generated on the substrate SUB through the pin hole PH between the second adhesive chuck PSC2 and the third adhesive chuck PSC3.

In an embodiment, the method may include performing step S8100 of providing the re-entry number with the initial value when the operation of pushing the substrate SUB by the second dechuck pin PN2 initiates (e.g., initiates for the first time).

Referring to FIGS. 12 to 16, at step S8200 of pushing the substrate SUB by the dechuck pin PN and acquiring pressure data by the pressure sensor FS, the method may include controlling the second dechuck pin PN2 such that the second dechuck pin PN2 contacts a portion of the substrate SUB and pushes the substrate SUB, and acquiring (e.g., using the pressure sensor FS) pressure data generated on the substrate SUB.

Descriptions herein of pushing the substrate SUB by the dechuck pin PN may include moving or extending the dechuck pin PN such that the dechuck pin PN pushes against the substrate SUB (i.e., applies a force against the substrate SUB).

In an embodiment, the pressure sensor FS of the second dechuck pin PN2 may maintain the operation of acquiring pressure data after a time point at which the first dechuck pin PN1 pushes the substrate SUB. For example, the pressure sensor FS of the second dechuck pin PN2 may measure pressure data generated on the substrate SUB after the time point at which the first dechuck pin PN1 pushes the substrate SUB.

For example, referring to FIG. 13, the pressure sensor FS of the second dechuck pin PN2 may measure pressure data generated on the substrate SUB in a first time period TS1, and may measure pressure data generated on the substrate SUB in a second time period TS2 after the first time period TS1. In an embodiment, pressure data measured by the pressure sensor FS in the first time period TS1 and the second time period TS2 may be used to control the operation of the second dechuck pin PN2.

Here, a first graph 1200 and a second graph 1400 may indicate pressure values acquired by the dechuck pin PN (e.g., the pressure sensor FS of the second dechuck pin PN2) over time. In FIG. 13, the first graph 1200 illustrates pressure data measured by the second dechuck pin PN2 over time in the first time period TS1. The second graph 1400 illustrates pressure data measured by the second dechuck pin PN2 over time in the second time period TS2. A first peak value 1240 may be a peak value of the first graph 1200, and the first peak value 1240 may be a pressure value measured at a time point in the first time period TS1 directly adjacent to the second time period TS2. The second peak value 1440 may be a peak value of the second graph 1400, and may be a pressure value measured at a final time point in the second time period TS2. An initial value 1420 may be initial data of the second graph 1400, and may be a pressure value measured at a time point in the second time period TS2 directly adjacent to the first time period TS1.

In an embodiment, in the first time period TS1, the second dechuck pin PN2 may push the rear surface of the substrate SUB, and the pressure sensor FS of the second dechuck pin PN2 may acquire pressure data. In the first time period TS1, the second dechuck pin PN2 may contact and push the rear surface of the substrate SUB, and the first dechuck pin PN1 may push the rear surface of the substrate SUB such that the first and second adhesive chucks PSC1 and PSC2 can be separated from the substrate SUB. Accordingly, during the first time period TS1 in the first graph 1200, the pressure value over time may increase. For example, as the first dechuck pin PN1 pushes the substrate SUB while the second adhesive chuck PSC2 and the substrate SUB remain coupled, the magnitude of stress generated on the substrate SUB may increase, thereby increasing the magnitude of the pressure data measured by the pressure sensor FS of the second dechuck pin PN2.

In an embodiment, while the first dechuck pin PN1 supports a portion of the rear surface of the substrate SUB, the second dechuck pin PN2 may push the substrate SUB, thereby spacing the second adhesive chuck PSC2 away from the substrate SUB. In an embodiment, immediately before the substrate SUB and the second adhesive chuck PSC2 are separated from each other, the first graph 1200 may have the first peak value 1240. Immediately after the substrate SUB and the second adhesive chuck PSC2 are separated from each other, stress generated between the second adhesive chuck PSC2 and the substrate SUB is removed, thereby allowing the initial value 1420 of the second graph 1400 to have a relatively low value. For example, the first peak value 1240 and the initial value 1420 may have a difference by a gap value G. Accordingly, in the case where the first adhesive chuck PSC1, the second adhesive chuck PSC2, and the third adhesive chuck PSC3 are separated from the substrate SUB sequentially along the dechuck direction DR_D, a time point at which the second adhesive chuck PSC2 and the substrate SUB are separated from each other may be a time point at which the first time period TS1 and the second time period TS2 are distinguished from each other.

In an embodiment, in the second time period TS2, the pressure sensor FS of the second dechuck pin PN2 may acquire pressure data, and the second dechuck pin PN2 may push the rear surface of the substrate SUB. In the second time period TS2, the second dechuck pin PN2 may contact and push the rear surface of the substrate SUB, and the first dechuck pin PN1 may support the rear surface of the substrate SUB between the first adhesive chuck PSC1 and the second adhesive chuck PSC2. Accordingly, during the second time period TS2 in the second graph 1400, the pressure value over time may increase. For example, as the second dechuck pin PN2 pushes the substrate SUB while the third adhesive chuck PSC3 and the substrate SUB remain coupled, the magnitude of stress generated on the substrate SUB may increase, thereby increasing the magnitude of the pressure data measured by the pressure sensor FS of the second dechuck pin PN2.

Referring to FIG. 12, after the second time period TS2 initiates, in the case where the pressure data acquired by the pressure sensor FS of the second dechuck pin PN2 meets a preset criterion, the method may include performing step S8340 of continuously pushing the substrate SUB using the dechuck pin PN and proceeding with the dechuck process.

For example, the step of determining whether the pressure data acquired by the pressure sensor FS meets the preset criterion may include step S8310 of determining whether the first pressure value is equal to or greater than the first reference value, step S8320 of determining whether the gap value is equal to or greater than the reference gap value, and step S8330 of determining whether the second pressure value is equal to or greater than the second reference value.

In an embodiment, at step S8310 of determining whether the first pressure value is equal to or greater than the first reference value, the method may include determining whether a pressure value acquired by the pressure sensor FS of the second dechuck pin PN2 in the first time period TS1 is equal to or greater than the first reference value.

The first reference value may be a preset reference value, and is not limited to a specific value. The first reference value may be data acquired experimentally, and may be determined based on a pressure value that can be acquired by the pressure sensor FS of the second dechuck pin FN2 in the case where the dechuck process proceeds abnormally.

In the case where the pressure value acquired by the pressure sensor FS of the second dechuck pin PN2 in the first time period TS1 (e.g., a pressure value of the first graph 1200 at a time point selected in the first time period TS1) is less than the first reference value, the second dechuck pin PN2 may continuously push the substrate SUB and proceed with the dechuck process (i.e., at step S8340).

In the case where the pressure value acquired by the pressure sensor FS of the second dechuck pin PN2 in the first time period TS1 is equal to or greater than the first reference value, step S8320 of determining whether the gap value is equal to or greater than the reference gap value may be performed.

In an embodiment, at step S8320 of determining whether the gap value is equal to or greater than the reference gap value, the method may include determining that the gap value G is equal to or greater than the reference gap value.

The reference gap value may be a preset reference value, and is not limited to a specific value. The reference gap value may be data acquired experimentally, and may be determined based on a pressure value that can be acquired by the pressure sensor FS of the second dechuck pin FN2 in the case where the dechuck process proceeds abnormally.

In the case where the gap value G is less than the reference gap value, the second dechuck pin PN2 may continuously push the substrate SUB and proceed with the dechuck process (i.e., step S8340).

In the case where the gap value G is equal to or greater than the reference gap value, step S8330 of determining whether the second pressure value is equal to or greater than the second reference value may be performed.

In an embodiment, at step S8330 of determining whether the second pressure value is equal to or greater than the second reference value, the method may include determining whether a pressure value acquired by the pressure sensor FS of the second dechuck pin PN2 in the second time period TS2 is equal to or greater than the second reference value.

The second reference value may be a preset reference value, and is not limited to a specific value. The second reference value may be data acquired experimentally, and may be determined based on a pressure value that can be acquired by the pressure sensor FS of the second dechuck pin FN2 in the case where the dechuck process proceeds abnormally.

In the case where the pressure value acquired by the pressure sensor FS of the second dechuck pin PN2 in the second time period TS2 (e.g., a pressure value of the second graph 1400 at a time point selected in the second time period TS2) is less than the second reference value, the second dechuck pin PN2 may continuously push the substrate SUB and proceed with the dechuck process (i.e., at step S8340).

In the case where the pressure value acquired by the pressure sensor FS of the second dechuck pin PN2 in the second time period TS2 is equal to or greater than the second reference value, the method may determine that the dechuck process proceeds abnormally, and the method may include performing subsequent process steps.

Because FIGS. 13 to 17 illustrate the case where the dechuck process proceeds normally, descriptions will be provided based on the case where the pressure data meets the preset criterion through at least one of step S8310 of determining whether the first pressure value is equal to or greater than the first reference value, step S8320 of determining whether the gap value is equal to or greater than the reference gap value, or step S830 of determining whether the second pressure value is equal to or greater than the second reference value, such that step S8340 of continuously pushing the substrate SUB using the dechuck pin PN and proceeding with the dechuck process is performed.

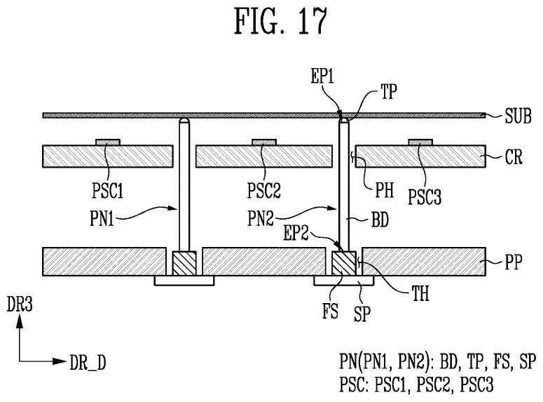

Referring to FIGS. 12 and 17, at step S8340 of continuously pushing the substrate SUB using the dechuck pin PN and proceeding with the dechuck process, the second dechuck pin PN2 may push the substrate SUB, and the third dechuck pin PN3 may be separated from the substrate SUB. Accordingly, the first to third adhesive chucks PSC1 to PSC3 formed around the first and second dechuck pins PN1 and PN2 may be separated from the substrate SUB.

As described herein, the first to third adhesive chucks PSC1 to PSC3 may be separated from the substrate SUB sequentially along the dechuck direction DR_D, such that acquired pressure data may be determined to meet the preset criterion, thus enabling the dechuck process to proceed appropriately in sequence.

With reference to FIG. 12, and 18 to 22, detailed steps of the unit dechuck process DC will be described for the case where the dechuck process is performed abnormally. For the sake of convenience in explanation, descriptions of content that overlap the content described herein will be simplified or omitted.

Referring to FIGS. 12, 19, and 20, at step S8000 of providing the substrate SUB and the carrier CR attached to each other by the adhesive chucks PSC, the method may include providing the substrate SUB and the carrier CR coupled to each other. In an embodiment, the first dechuck pin PN1 may push the rear surface of the substrate SUB through the pin hole PH between the first adhesive chuck PSC1 and the second adhesive chuck PSC2, thus spacing the first adhesive chuck PSC1 away from the substrate SUB.

Referring to FIGS. 12, 19, and 20, at step S8100 of providing the re-entry number with the initial value, the method may include providing an initial value of 0 for the re-entry number, which indicates information about the number of operations of the second dechuck pin PN2. In an embodiment, the second dechuck pin PN2 may acquire information about pressure generated on the substrate SUB through the pin hole PH between the second adhesive chuck PSC2 and the third adhesive chuck PSC3.

Referring to FIG. 12, and 18 to 22, at step S8200 of pushing the substrate SUB by the dechuck pin PN and acquiring pressure data by the pressure sensor FS, the method may include controlling the second dechuck pin PN2 such that the second dechuck pin PN2 contacts a portion of the substrate SUB and pushes the substrate SUB, and acquiring (e.g., via the pressure sensor FS) pressure data generated on the substrate SUB.

Referring to FIG. 18, the method may include measuring, using the pressure sensor FS of the second dechuck pin PN2, pressure data generated on the substrate SUB in a first time period TS1′, and measuring pressure data generated on the substrate SUB in a second time period TS2′ after the first time period TS1′. In an embodiment, the method may include controlling the operation of the second dechuck pin PN2 based on pressure data measured by the pressure sensor FS in the first time period TS1′ and the second time period TS2′

In FIG. 18, the first graph 1200′ illustrates pressure data measured by the second dechuck pin PN2 over time in the first time period TS1′. The second graph 1400′ illustrates pressure data measured by the second dechuck pin PN2 over time in the second time period TS2′. A first peak value 1240′ may be a peak value of the first graph 1200′, and may be a pressure value measured at a time point in the first time period TS1′ directly adjacent to the second time period TS2′. The second peak value 1440′ may be a peak value of the second graph 1400′, and may be a pressure value measured at a final time point in the second time period TS2′. An initial value 1420′ may be initial data of the second graph 1400′, and may be a pressure value measured at a time point in the second time period TS2′ directly adjacent to the first time period TS1′.

In an embodiment, in the first time period TS1′, the pressure sensor FS of the second dechuck pin PN2 may acquire pressure data, and the second dechuck pin PN2 may push the rear surface of the substrate SUB. In the first time period TS1′, the second dechuck pin PN2 may contact and push the rear surface of the substrate SUB, and the first dechuck pin PN1 may push the rear surface of the substrate SUB such that the first adhesive chucks PSC1 can be separated from the substrate SUB. Accordingly, during the first time period TS1′ in the first graph 1200′, the pressure value over time may increase.

In an embodiment, while the first dechuck pin PN1 supports a portion of the rear surface of the substrate SUB, the second dechuck pin PN2 may push the substrate SUB, thereby spacing the second adhesive chuck PSC2 away from the substrate SUB. In an embodiment, immediately before the substrate SUB and the second adhesive chuck PSC2 are separated from each other, the first graph 1200′ may have the first peak value 1240′. Immediately after the substrate SUB and the second adhesive chuck PSC2 are separated from each other, stress generated between the second adhesive chuck PSC2 and the substrate SUB is removed, thereby allowing the initial value 1420′ of the second graph 1400′ to have a relatively low value. For example, the first peak value 1240′ and the initial value 1420′ may have a difference by a gap value G′. Accordingly, in the case where the first adhesive chuck PSC1, the second adhesive chuck PSC2, and the third adhesive chuck PSC3 are not separated from the substrate SUB sequentially along the dechuck direction DR_D (e.g., in the case where the first, second, and third adhesive chucks PSC1, PSC2, and PSC3 are separated from the substrate SUB in the order of the first adhesive chuck PSC1, the third adhesive chuck PSC3, and second adhesive chuck PSC2), a time point at which the third adhesive chuck PSC3 and the substrate SUB are separated from each other may be a time point at which the first time period TS1 and the second time period TS2 are distinguished from each other.

In an embodiment, in the second time period TS2′, the pressure sensor FS of the second dechuck pin PN2 may acquire pressure data, and the second dechuck pin PN2 may push the rear surface of the substrate SUB. In the second time period TS2′, the second dechuck pin PN2 may contact and push the rear surface of the substrate SUB, and the first dechuck pin PN1 may support the rear surface of the substrate SUB at a position adjacent to the first adhesive chuck PSC1. Accordingly, during the second time period TS2′ in the second graph 1400′, the pressure value over time may increase.

Referring to FIG. 12, after the second time period TS2′ initiates, in the case where the pressure data acquired by the pressure sensor FS of the second dechuck pin PN2 meets a preset criterion, the method may include performing step S8340 of continuously pushing the substrate SUB using the dechuck pin PN and proceeding with the dechuck process.

For example, in accordance with an embodiment, the step of determining whether the pressure data acquired by the pressure sensor FS meets the preset criterion may include step S8310 of determining whether the first pressure value is equal to or greater than the first reference value, step S8320 of determining whether the gap value is equal to or greater than the reference gap value, and step S8330 of determining whether the second pressure value is equal to or greater than the second reference value.

In an embodiment, at step S8310 of determining whether the first pressure value is equal to or greater than the first reference value, the method may include determining whether a pressure value acquired by the pressure sensor FS of the second dechuck pin PN2 in the first time period TS1′ is equal to or greater than the first reference value.

In an embodiment, in the case where the pressure value acquired by the pressure sensor FS of the second dechuck pin PN2 in the first time period TS1′ is equal to or greater than the first reference value, step S8320 of determining whether the gap value is equal to or greater than the reference gap value may be performed.

In an embodiment, in the first time period TS1′, when the first dechuck pin PN1 pushes the substrate SUB to separate the second adhesive chuck PSC2 from the substrate SUB, the pressure sensor FS of the second dechuck pin PN2 may measure the pressure data. Here, in the case where the second adhesive chuck PSC2 and the substrate SUB are excessively strongly coupled to each other, the second adhesive chuck PSC2 may not be properly separated from the substrate SUB. As the first dechuck pin PN1 pushes the substrate SUB even though the second adhesive chuck PSC2 and the substrate SUB are not properly separated, relatively high stress may be generated around the second adhesive chuck PSC2. In this case, a pressure value measured by the pressure sensor FS of the second dechuck pin PN2 in the first time period TS1′ may have a relatively high value. Accordingly, in the case where the method determines that the pressure value (e.g., the first peak value 1240′) acquired by the pressure sensor FS of the second dechuck pin PN2 is equal to or greater than the first reference value, the method may include determining (i.e. interpreting) that at least some of the adhesive chucks PSC (e.g., the second adhesive chuck PSC2) and the substrate SUB are abnormally strongly coupled to each other, and accordingly, determining that the dechuck process has proceeded abnormally.

In an embodiment, in the case where the gap value G′ is equal to or greater than the reference gap value, the method may include performing step S8330 of determining whether the second pressure value is equal to or greater than the second reference value.

In an embodiment, in the case where the dechuck process proceeds abnormally, when the first dechuck pin PN1 may support a portion of the rear surface of the substrate SUB and the second dechuck pin PN2 pushes the substrate SUB, the second adhesive chuck PSC2 and the substrate SUB may remain coupled to each other while the third adhesive chuck PSC3 may be separated from the substrate SUB. For example, the case where the dechuck process proceeds normally may refer to the second adhesive chuck PSC2 being separated from the substrate SUB earlier than the third adhesive chuck PSC3. However, in the case where the second adhesive chuck PSC2 is excessively strongly coupled to the substrate SUB, the order of the separation between the adhesive chucks PSC and the substrate SUB may be reversed with respect to the dechuck direction DR. In this case, with relatively high stress generated between the second adhesive chuck PSC2 and the substrate SUB, the stress between the third adhesive chuck PSC3 and the substrate SUB may be removed such that the gap value G′ may have a relatively high value compared to the case where the dechuck process proceeds normally. Accordingly, in the case where the gap value G′ is determined to be equal to or greater than the reference gap value, the method may include determining (i.e., interpreting) that the second adhesive chuck PSC2 and the substrate SUB are abnormally strongly coupled, and accordingly, determining that the dechuck process has proceeded abnormally.

In an embodiment, in the case where the pressure value acquired by the pressure sensor FS of the second dechuck pin PN2 in the second time period TS2′ is equal to or greater than the second reference value, the process may determine that the dechuck process proceeds abnormally, and the method may include performing subsequent process steps.

In an embodiment, in the case where the dechuck process proceeds abnormally, when the first dechuck pin PN1 supports a portion of the rear surface of the substrate SUB and the second dechuck pin PN2 pushes the substrate SUB, the second adhesive chuck PSC2 and the substrate SUB may remain coupled to each other while the third adhesive chuck PSC3 may be separated from the substrate SUB. As a result, relatively high stress may be generated between the second adhesive chuck PSC2 and the substrate SUB, and the pressure value acquired by the second dechuck pin PN2 in the second time period TS2′ (e.g., a pressure value of the second graph 1400 at a time point selected in the second time period TS2) may have a relatively high value compared to the case where the dechuck process proceeds normally. Accordingly, in the case where the method determines that the second pressure value is equal to or greater than the second reference value, the method may include determining (i.e., interpreting) that the second adhesive chuck PSC2 and the substrate SUB are abnormally strongly coupled to each other and thus remain coupled during the second time period TS2′, and determining that the dechuck process has proceeded abnormally.

Consequently, in an embodiment, using the pressure sensor FS included in the dechuck pin PN, the process may determine whether the dechuck process proceeds normally based on preset criteria.

In an embodiment, in the case where the method determines that the first pressure value is equal to or greater than the first reference value at step S8310 of determining whether the first pressure value is equal to or greater than the first reference value, it is determined that the gap value G′ is equal to or greater than the reference gap value at step S8320 of determining whether the gap value is equal to or greater than the reference gap value, and it is determined that the second pressure value is equal to or greater than the second reference value at step S8330 of determining whether the second pressure value is equal to or greater than the second reference value, the method may include performing step S8350 of providing a warning signal.

As a result, based on the pressure data acquired by the pressure sensor FS, embodiments of the present disclosure support clearly analyzing whether the dechuck process proceeds normally, and automated equipment can be implemented. Consequently, the process yield may be improved, and user convenience may be ensured.

Furthermore, based on the pressure data, whether the dechuck process proceeds normally may be determined in a serial order of multiple criteria. Consequently, the analysis reliability of the dechuck process may be improved.

At step S8350 of providing the warning signal, the method may include providing information indicating that the dechuck process is determined to proceed abnormally to the user.

Depending on the embodiment, the warning signal may be an audio signal or a visual signal. For example, the dechuck control system SYS may include a warning providing component capable of providing a warning signal. In an embodiment, the warning providing component may include an audio providing component and/or a visual providing component (such as, for example, a display). In an embodiment, the warning providing component may be included in a device including any one of the first to third controllers CON1 to CON3. However, the disclosure is not limited to the aforementioned example.

At step S8360 of spacing the dechuck pin PN away from the substrate SUB, suspending acquisition of the pressure data by the pressure sensor FS, and increasing a re-entry number by 1, the dechuck process using the second dechuck pin PN2 may be suspended.

At step S8360, the first dechuck pin PN1 may continuously support the lower portion of the support SUB, and the second dechuck pin PN2 may be separated from the substrate SUB. Accordingly, the push operation of the second dechuck pin PN2 on the substrate SUB may be released, and the pressure measurement operation of the pressure sensor FS of the second dechuck pin PN2 on the substrate SUB may be released.

In an embodiment, the method may include performing step S8360 after step S8350 of providing a warning signal. However, the disclosure is not limited to the foregoing example. For example, the method may include performing the step S8360 before step S8350 of providing a warning signal.

At step S8360, the method may include increasing the re-entry number for the dechuck process of the second dechuck pin PN2. Accordingly, the re-entry number may be determined based on the number of times a preceding cycle has been performed.

At step S8370 of determining whether the re-entry number is greater than the setting count, the method may include comparing the re-entry number with the setting count.

In an embodiment, the setting count may be a preset number of times for repeating the preceding cycle. For example, in the case where the setting count is n (n is a natural number of 1 or more), the preceding cycle may be repeated (n+1) times.

At step S8370, in response to determining the re-entry number is equal to or less than the setting count, the method may include again performing step S8200 of pushing the substrate SUB by the dechuck pin PN and acquiring pressure data by the pressure sensor FS, and subsequently, again performing steps, such as, for example, determining whether the dechuck process proceeds normally according to the preset criteria based on the pressure data.

In an embodiment, at step S8370, in response to determining that the re-entry number is not greater than the setting count and again performing step S8200 of pushing the substrate SUB by the dechuck pin PN and acquiring pressure data by the pressure sensor FS, the method may include reducing the push speed (i.e., a movement speed according to which the second dechuck pin PN2 is extended toward the substrate SUB) of the second dechuck pin PN2 and controlling the second dechuck pin PN2 according to the reduced push speed. Accordingly, in the case where the method determines that the dechuck process proceeds partially abnormally, the method may include pushing the substrate SUB with the second dechuck pin PN2 according to a reduced push speed, thereby allowing the dechuck process to proceed with a reduced risk of damaging the substrate SUB.

At step S8370, in response to determining that the re-entry number is greater than the setting count, the method may include suspending the dechuck process for the second dechuck pin PN2 is suspended, and performing step S8380 of providing an alarm signal.

At step S8380 of providing an alarm signal, the method may include providing an alarm signal to inform the user of whether to suspend the dechuck process for the case in which the dechuck process proceeds abnormally. Accordingly, based on reviewing the alarm signal and determining it is difficult for the dechuck process to proceed properly, the user is able to check information about the progress of the dechuck process and whether repair (e.g., to a dechuck pin PN, the substrate SUB, or the like) is to be performed, relatively early.

Depending on the embodiment, the alarm signal may be an audio signal or a visual signal. For example, the dechuck control system SYS may include an alarm providing component capable of providing an alarm signal. In an embodiment, the alarm providing component may include an audio providing component and/or a visual providing component (such as, for example, a display). In an embodiment, the alarm providing component may be included in a device including any one of the first to third controllers CON1 to CON3. However, the disclosure is not limited to the aforementioned example.

Consequently, in an embodiment, the push operation for performing the dechuck process of the dechuck pins PN may be controlled based on the pressure data, thereby reducing the risk of damage to the substrate SUB. As a result, the process of separating the carrier CR and the substrate SUB to each other may be performed properly, and the process reliability may be improved.

Various embodiments of the disclosure may provide a dechuck control method, a dechuck control system, and a method of transferring a substrate, in which the reliability of the dechuck process with respect to the substrate and a carrier can be improved, thereby preventing damage to the substrate or the like.

Various embodiments of the disclosure may provide a dechuck control method, a dechuck control system, and a method of transferring a substrate, in which process costs can be reduced and process monitoring with improved user convenience can be implemented.

Various embodiments of the disclosure may provide a dechuck control method, a dechuck control system, and a method of transferring a substrate, in which whether individual steps of a dechuck process have been performed normally can be analyzed quantitatively.

While various embodiments have been described herein, those skilled in the art will appreciate that various modifications, additions and substitutions are possible, without departing from the scope and spirit of the disclosure.

Therefore, the embodiments disclosed in this specification are for illustrative purposes rather than limiting the technical spirit of the disclosure. The scope of the disclosure may be defined by the accompanying claims.

What is claimed is:

1. A dechuck control method, comprising:
providing a substrate and a carrier coupled to each other by an adhesive chuck;
pushing the substrate by a dechuck pin comprising a pressure sensor, and acquiring, by the pressure sensor, pressure data associated with pushing the substrate by the dechuck pin; and
controlling an operation of the dechuck pin based on the pressure data.

2. The dechuck control method of claim 1, wherein:
the adhesive chuck comprises a first adhesive chuck, a second adhesive chuck, and a third adhesive chuck arranged sequentially along a dechuck direction;
the dechuck pin comprises:
a first dechuck pin between the first adhesive chuck and the second adhesive chuck, and
a second dechuck pin between the second adhesive chuck and the third adhesive chuck,
acquiring the pressure data comprises acquiring the pressure data by a pressure sensor of the second dechuck pin while the second dechuck pin pushes the substrate; and
the pressure data acquired by the pressure sensor of the second dechuck pin is expressed as a first graph and a second graph, each representing a pressure value over time, wherein:
the first graph indicates the pressure value over time in a first time period, and
the second graph indicates the pressure value over time in a second time period following the first time period, and
the first graph has a first peak value of the pressure value, the second graph has an initial value and a second peak value of the pressure value, and the first peak value and the initial value differ from each other by a gap value.

3. The dechuck control method of claim 2, wherein for a case in which the first adhesive chuck, the second adhesive chuck, and the third adhesive chuck are sequentially separated from the substrate along the dechuck direction, a time point at which the first time period and the second time period are distinguished from each other corresponds to a time point at which the second adhesive chuck and the substrate are separated from each other.

4. The dechuck control method of claim 2, wherein for a case in which the first adhesive chuck, the second adhesive chuck, and the third adhesive chuck are not sequentially separated from the substrate along the dechuck direction, a time point at which the first time period and the second time period are distinguished from each other corresponds to a time point at which the third adhesive chuck and the substrate are separated from each other.

5. The dechuck control method of claim 2, wherein controlling the operation of the dechuck pin comprises continuously pushing the substrate by the second dechuck pin in response to determining the pressure data meets a preset criterion.

6. The dechuck control method of claim 2, wherein controlling the operation of the dechuck pin comprises:
determining whether the pressure value as indicated in the first graph in the first time period is equal to or greater than a first reference value;
in response to determining the pressure value as indicated in the first graph is equal to or greater than the first reference value, continuously pushing the substrate by the dechuck pin; and
in response to determining the pressure value as indicated in the first graph is less than the first reference value, determining whether the gap value is equal to or greater than a reference gap value.

7. The dechuck control method of claim 6, further comprising:
in response to determining the gap value is equal to or greater than the reference gap value, continuously pushing the substrate by the dechuck pin; and
in response to determining the gap value is less than the reference gap value, determining whether the pressure value as indicated in the second graph in the second time period is equal to or greater than a second reference value.

8. The dechuck control method of claim 7, further comprising:
in response to determining the pressure value as indicated in the second graph is equal to or greater than the second reference value, continuously pushing the substrate by the dechuck pin; and
in response to determining the pressure value as indicated in the second graph is less than the second reference value, providing a warning signal.

9. The dechuck control method of claim 8, wherein controlling the operation of the dechuck pin further comprises:
providing a re-entry number with an initial value when the second dechuck pin initially pushes the substrate; and
after providing the warning signal, controlling the second dechuck pin such that the second dechuck pin is spaced apart from the substrate, suspending acquiring the pressure data by the pressure sensor of the second dechuck pin, and increasing the re-entry number by 1.

10. The dechuck control method of claim 9, wherein controlling the operation of the dechuck pin further comprises determining whether the re-entry number is greater than a setting count.

11. The dechuck control method of claim 10, further comprising providing an alarm signal in response to determining the re-entry number is greater than the setting count.

12. The dechuck control method of claim 11, further comprising, in response to determining the re-entry number is equal to or less than the setting count:
pushing the substrate by the second dechuck pin according to a reduced push speed;
and reacquiring the pressure data by the pressure sensor of the second dechuck pin.

13. A dechuck control system, comprising:
an adhesive chuck which attaches a carrier comprising a pin hole to a substrate;
a dechuck pin which pushes the substrate in a direction through the pin hole and comprising a pressure sensor which acquires pressure data; and
a controller which receives the pressure data and controls an operation of the dechuck pin based on the pressure data.

14. The dechuck control system of claim 13, wherein:
the carrier comprises a middle area and a peripheral area formed around the middle area and forming a dummy area;
a chuck area where the pin hole and the adhesive chuck are positioned is formed in the middle area; and
the chuck area comprises a plurality of portions each extending in a direction.

15. The dechuck control system of claim 14, wherein the pin hole and the adhesive chuck are alternately arranged in the chuck area.

16. The dechuck control system of claim 13, wherein the dechuck pin comprises:
a body part comprising a first end and a second end;
a tip provided on the first end and capable of pushing the substrate; and
a pressure sensor provided on the second end.

17. The dechuck control system of claim 13, further comprising a pin plate comprising a plate hole, wherein the pressure sensor is located in the plate hole.

18. The dechuck control system of claim 13, further comprising:
a signal amplifier connected to the pressure sensor; and
a controller which provides a pressure measurement initiation signal to the signal amplifier, receive pressure information from the signal amplifier, and provide an operation control signal to the pressure sensor.

19. A transfer method, comprising:
providing a substrate on a carrier;
transferring the substrate;
coupling the substrate and the carrier by an adhesive chuck;
performing a certain process on the substrate; and
performing a dechuck process with respect to the substrate and the carrier,
wherein:
performing the dechuck process comprises performing a plurality of unit dechuck processes, and
performing each of the plurality of unit dechuck processes comprises:
providing the substrate and the carrier in a state in which the substrate and the carrier are attached to each other by the adhesive chuck;
pushing the substrate by a dechuck pin, and acquiring, by a pressure sensor, pressure data associated with pushing the substrate by the dechuck pin; and
controlling an operation of the dechuck pin based on the pressure data.

20. The transfer method of claim 19, wherein:
the certain process comprises a deposition process; and
performing the dechuck process comprises, as operations respectively corresponding to the plurality of unit dechuck processes, performing a first dechuck process using a first dechuck pin, and performing a second dechuck process using a second dechuck pin.
